(19) United States
(12) Patent Application Publication
(10) Pub. No.: US 2023/0367311 A1
(43) Pub. Date: Nov. 16, 2023

(54) REMOTE MONITORING SYSTEM, REMOTE MONITORING APPARATUS, AND REMOTE MONITORING METHOD

(71) Applicant: NEC Corporation, Minato-ku, Tokyo (JP)

(72) Inventors: Hayato ITSUMI, Tokyo (JP); Koichi NIHEI, Tokyo (JP); Takanori IWAI, Tokyo (JP); Yusuke SHINOHARA, Tokyo (JP); Florian BEYE, Tokyo (JP); Charvi VITTHAL, Tokyo (JP)

(73) Assignee: NEC Corporation, Minato-ku, Tokyo (JP)

(21) Appl. No.: 18/029,294

(22) PCT Filed: Oct. 2, 2020
(86) PCT No.: PCT/JP2020/037655

§ 371 Date: Mar. 29, 2023

(51) Int. Cl. G05D 1/00

(52) U.S. Cl. CPC G05D 1/0038; G05D 1/0077; G05D 2201/0213

(57) ABSTRACT

A monitoring person can rapidly take a countermeasure against a situation occurring in a moving object. Image reception means (31) receives image data obtained by imaging the outside of the moving object. Candidate acquisition means (32) acquires control content candidates of autonomous driving of the moving object. Monitoring screen display means (33) causes a display apparatus to display a monitoring screen. The monitoring screen includes a region where the image data is displayed and a region where the control content candidates are displayed. When one control content is selected from the control content candidates, control content transmission means (34) transmits a control signal representing the selected control content to the moving object.

### TECHNICAL FIELD

The present disclosure relates to a remote monitoring system, a remote monitoring apparatus, and a remote monitoring method.

### BACKGROUND ART

The technological development of self-driving vehicles has become active, and public road driving tests or trial operations of self-driving vehicles have progressed at home and abroad. In order to secure the safety of self-driving vehicles, needs for remote monitoring of self-driving vehicles using mobile communication or remote control at the time of contingency have increased.

In the related art, Patent Literature 1 discloses a remote monitoring system that remotely monitors an autonomous vehicle. In the remote monitoring system described in Patent Literature 1, the autonomous vehicle includes an autonomous sensor including a camera. The autonomous vehicle detects an obstacle based on information acquired from the autonomous sensor. When the autonomous vehicle detects an obstacle having a risk of collision, the vehicle travels at a reduced speed. In addition, the autonomous vehicle transmits a vehicle slow down signal and a camera image of the periphery of the vehicle obtained using a camera to a remote monitoring center.

In the remote monitoring center, a monitoring person monitors a camera image of the periphery of an autonomous vehicle received from the vehicle. The monitoring person checks a periphery situation of the autonomous vehicle from the camera image. When the monitoring person determines that the autonomous vehicle needs to be stopped, the monitoring person stops the autonomous vehicle. When the monitoring person determines that it is okay to restart traveling, the monitoring person operates an HMI (Human Machine Interface) to transmit a departure signal from a computer of the monitoring center to the autonomous vehicle. The autonomous vehicle continues to travel at a reduced speed until it receives the departure signal or is instructed to stop. When the departure signal is received, the autonomous vehicle restarts traveling.

As another example of the related art, Patent Literature 2 discloses a self-driving public transportation system. In the system described in Patent Literature 2, a vehicle capable of self-driving determines whether or not the state of the vehicle is a state where it is difficult to continue self-driving based on peripheral information generated using a sensor. When the vehicle determines that the state of the vehicle is a state where it is difficult to continue self-driving, the vehicle transmits a request including the type of a content of the peripheral information to a management apparatus.

When the request is received, the management apparatus executes a process according to the content of the peripheral information. For example, when the periphery of the vehicle is temporarily in a state where it is difficult to execute self-driving, the management apparatus switches the vehicle to remote control. When the request represents that the periphery of the vehicle is in a state where it is difficult to execute self-driving for a long period of time, the management apparatus presents an alternative route to an operator. When the operator selects the alternative route, a new route is transmitted to the vehicle, and the vehicle executes self-driving along the received route.

### CITATION LIST

### Patent Literature

Patent Literature 1: Japanese Unexamined Patent Application Publication No. 2019-87015

Patent Literature 2: Japanese Unexamined Patent Application Publication No. 2019-207539

### SUMMARY OF INVENTION

### Technical Problem

In Patent Literature 1, when an obstacle having a risk of collision is detected, the autonomous vehicle travels at a reduced speed. The monitoring person checks an image received from the autonomous vehicle and instructs the autonomous vehicle to restart or stop traveling. In Patent Literature 1, the monitoring person may select to restart traveling the autonomous vehicle that travels at a reduced speed or to stop the autonomous vehicle. However, in the remote monitoring of the autonomous vehicle, it is considered that a countermeasure needs to be taken against various situations in addition to collision with a front obstacle. In Patent Literature 1, the monitoring person needs to grasp which countermeasure can be taken against various situations occurring in the autonomous vehicle. Therefore, there is a possibility that the monitoring person cannot rapidly take a countermeasure against the situation occurring in the autonomous vehicle.

In Patent Literature 2, the management apparatus executes remote control, a change in route, or the like depending on reasons why self-driving cannot be continued. However, in Patent Literature 2, when an occurred situation is a situation where self-driving cannot be continued for a long period of time, the monitoring person only approves or selects a new route. In Patent Literature 2, when the monitoring person checks the state of the periphery of a vehicle where a situation that makes self-driving difficult to continue occurs and controls the vehicle based on the result, the monitoring person needs to grasp a solution to each situation that occurs. Therefore, even in Patent Literature 2, there is a possibility that the monitoring person cannot rapidly take a countermeasure against a situation where self-driving cannot be continued.

The present disclosure has been made in consideration of the above-described circumstances, and an object thereof is to provide a remote monitoring system, a remote monitoring apparatus, and a remote monitoring method with which a monitoring person can rapidly take a countermeasure against a situation occurring in a moving object even when the monitoring person does not grasp which countermeasure can be taken against various situations of the moving object.

### Solution to Problem

In order to achieve the above-described object, the present disclosure provides a remote monitoring system as a first aspect. The remote monitoring system includes: one or more moving objects configured to be capable of autonomous driving; and a remote monitoring apparatus that is used for monitoring the moving objects. The remote monitoring apparatus includes: image reception means for receiving image data obtained by imaging an outside of the moving object from the moving object; candidate acquisition means for acquiring control content candidates including one or more control contents of autonomous driving based on information regarding autonomous driving in the moving object; monitoring screen display means for causing a display apparatus to display a monitoring screen including a region where the image data is displayed and a region where the control content candidates are displayed; and control content transmission means for transmitting, when one control content is selected from the control content candidates, a control signal representing the selected control content to the moving object. In the remote monitoring system, the moving object receives the control signal transmitted from the control content transmission means, and executes autonomous driving according to the control content represented by the received control signal.

The present disclosure provides a remote monitoring apparatus as a second aspect. The remote monitoring apparatus includes: image reception means for receiving, from a moving object configured to be capable of autonomous driving, image data obtained by imaging an outside of the moving object; candidate acquisition means for acquiring control content candidates including one or more control contents of autonomous driving based on information regarding autonomous driving in the moving object; monitoring screen display means for causing a display apparatus to display a monitoring screen including a region where the image data is displayed and a region where the control content candidates are displayed; and control content transmission means for transmitting, when one control content is selected from the control content candidates, a control signal representing the selected control content to the moving object.

The present disclosure provides a remote monitoring method as a third aspect. The remote monitoring method includes: receiving, from a moving object configured to be capable of self-driving, image data obtained by imaging an outside of the moving object; acquiring control content candidates including one or more control contents of autonomous driving based on information regarding autonomous driving in the moving object; causing a display apparatus to display a monitoring screen including a region where the image data is displayed and a region where the control content candidates are displayed; and transmitting, when one control content is selected from the control content candidates, a control signal representing the selected control content to the moving object.

### Advantageous Effects of Invention

In the remote monitoring system, the remote monitoring apparatus, and the remote monitoring method according to the present disclosure, even when a monitoring person does not accurately grasp which countermeasure can be taken against various situations of a moving object, the monitoring person can rapidly take a countermeasure against a situation occurring in the moving object.

### BRIEF DESCRIPTION OF DRAWINGS

FIG. 1 is a block diagram illustrating a schematic configuration of a remote monitoring system according to the present disclosure;

FIG. 2 is a block diagram illustrating a schematic configuration of a remote monitoring apparatus;

FIG. 3 is a flowchart illustrating a schematic operation procedure in the remote monitoring apparatus;

FIG. 4 is a block diagram illustrating a remote monitoring system according to one example embodiment of the present disclosure;

FIG. 5 is a block diagram illustrating a configuration example of a moving object;

FIG. 6 is a block diagram illustrating a configuration example of the remote monitoring apparatus;

FIG. 7 is a block diagram illustrating a configuration example of a situation recognition unit;

FIG. 8 is a diagram illustrating a correspondence between a situation of the moving object and control contents;

FIG. 9 is a diagram illustrating an example of a monitoring screen;

FIG. 10 is a flowchart illustrating an operation procedure of the remote monitoring apparatus;

FIG. 11 is a diagram illustrating a first display example of the monitoring screen;

FIG. 12 is a diagram illustrating a second display example of the monitoring screen;

FIG. 13 is a diagram illustrating a third display example of the monitoring screen;

FIG. 14 is a diagram illustrating a fourth display example of the monitoring screen;

FIG. 15 is a diagram illustrating a fifth display example of the monitoring screen;

FIG. 16 is a diagram illustrating a sixth display example of the monitoring screen;

FIG. 17 is a diagram illustrating a display example of monitoring screens of a plurality of moving objects;

FIG. 18 is a diagram illustrating another display example of a monitoring screen of a plurality of moving objects; and

FIG. 19 is a block diagram illustrating a configuration example of a computer apparatus.

### EXAMPLE EMBODIMENT

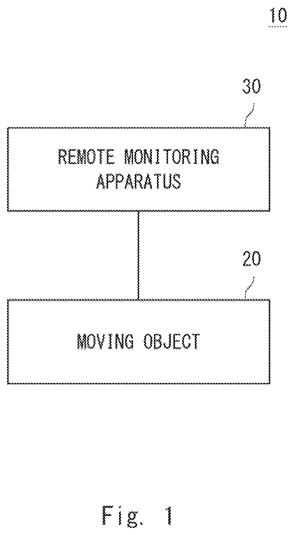

Before describing an example embodiment of the present disclosure, the summary of the present disclosure will be described. FIG. 1 illustrates a schematic configuration of a remote monitoring system according to the present disclosure. A remote monitoring system 10 includes a moving object 20 and a remote monitoring apparatus 30. The moving object 20 is configured to be capable of autonomous driving. The remote monitoring apparatus 30 is used for monitoring the moving object 20.

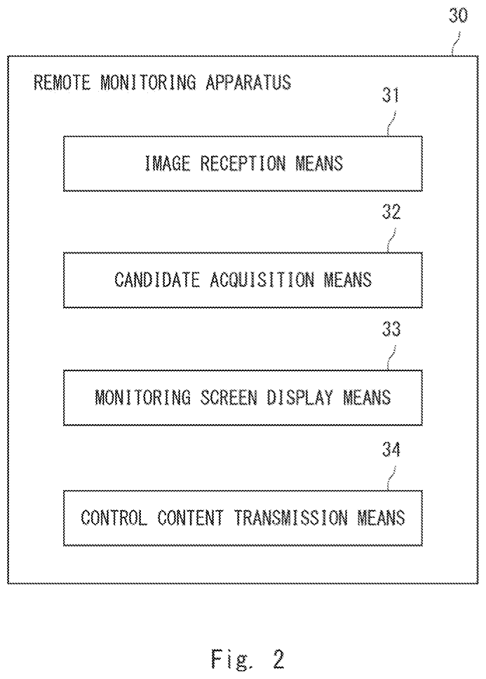

FIG. 2 illustrates a schematic configuration of the remote monitoring apparatus. The remote monitoring apparatus 30 includes image reception means 31, candidate acquisition means 32, monitoring screen display means 33, and control content transmission means 34. The image reception means 31 receives image data obtained by imaging the outside of the moving object 20 from the moving object 20 (refer to FIG. 1). The candidate acquisition means 32 acquires control content candidates of autonomous driving of the moving object 20 based on information regarding autonomous driving in the moving object 20. The control content candidates include one or more control contents of autonomous driving.

The monitoring screen display means 33 causes a display apparatus to display a monitoring screen. The monitoring screen includes a region where the image data received from the moving object 20 is displayed and a region where the control content candidates acquired by the candidate acquisition means 32 are displayed. When one control content is selected from the control content candidates, the control content transmission means 34 transmits a control signal representing the selected control content to the moving object 20. The moving object 20 receives the control signal transmitted from the control content transmission means 34, and executes autonomous driving according to the control content represented by the received control signal.

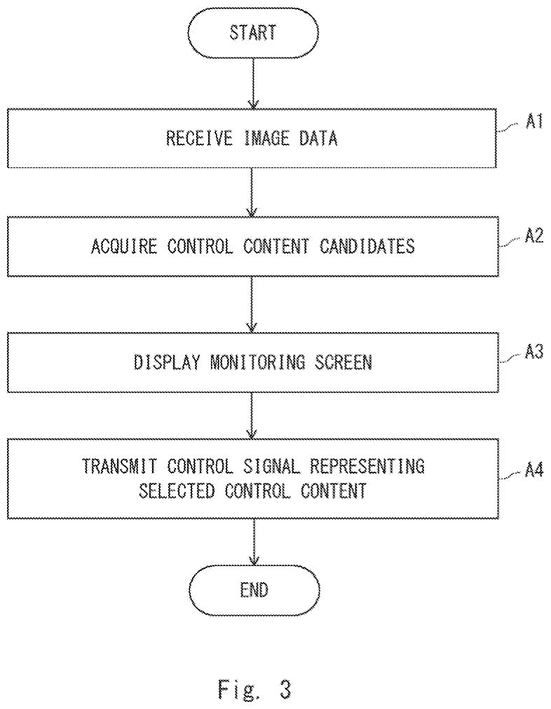

Next, an operation procedure will be described. FIG. 3 illustrates a schematic operation procedure (remote monitoring method) in the remote monitoring apparatus. The image reception means 31 receives image data from the moving object 20 (Step A1). The candidate acquisition means 32 acquires control content candidates of autonomous driving of the moving object 20 based on information regarding autonomous driving in the moving object 20 (Step A2). The monitoring screen display means 33 causes a display apparatus to display a monitoring screen (Step A3). When one control content is selected from the control content candidates, the control content transmission means 34 transmits a control signal representing the selected control content to the moving object 20 (Step A4).

In the present disclosure, the candidate acquisition means 32 acquires control content candidates of autonomous driving of the moving object 20 based on information regarding autonomous driving in the moving object 20. The monitoring screen display means 33 causes the acquired control content candidates to be included in the monitoring screen displayed by the display apparatus. In the present disclosure, a monitoring person who sees the display apparatus to monitor the moving object 20 can select a control content to be applied to the moving object 20 from the control content candidates displayed on the monitoring screen. Therefore, even when the monitoring person does not grasp in advance which countermeasure can be taken against various situations occurring in an autonomous vehicle, the monitoring person can rapidly take a countermeasure against an occurred situation.

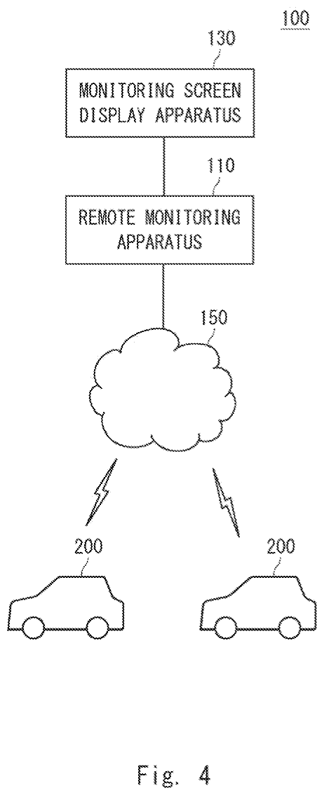

Hereinafter, an example embodiment of the present disclosure will be described. FIG. 4 is a block diagram illustrating a remote monitoring system according to one example embodiment of the present disclosure. A remote monitoring system 100 includes a remote monitoring apparatus 110, a monitoring screen display apparatus 130, and a moving object 200. The remote monitoring apparatus 110 is an apparatus for remotely monitoring the moving object 200. The remote monitoring apparatus 110 may be capable of remotely operating the moving object 200. The monitoring screen display apparatus 130 is a display apparatus for displaying information used for monitoring the moving object 200 to the monitoring person (operator). The monitoring screen display apparatus 130 does not need to be an apparatus independent from the remote monitoring apparatus 110 and may be a part of the remote monitoring apparatus 110. The monitoring screen display apparatus 130 may be configured as an apparatus such as a liquid crystal display apparatus. The remote monitoring apparatus 110 corresponds to the remote monitoring apparatus 30 illustrated in FIG. 1.

The remote monitoring apparatus 110 is connected to the moving object 200 via a network 150. The network 150 includes a wireless communication network using a communication line standard such as LTE (Long Term Evolution). The network 150 may include a wireless communication network such as WiFi (registered tradename) or the fifth generation mobile communication system.

The moving object 200 is remotely monitored by the remote monitoring apparatus 110. The moving object 200 is configured as a land vehicle such as an automobile, a bus, a taxi, or a truck. The moving object 200 may be configured to be capable of self-driving (autonomous driving) based on information of a sensor mounted on the moving object. For example, the moving object 200 may be configured to be switchable between self-driving and manual driving by a driver in the vehicle. The moving object 200 may switch from manual driving to self-driving or from self-driving to manual driving, for example, in response to an instruction transmitted from the remote monitoring apparatus 110. The moving object 200 may be a train, a ship, or an airplane or may be a moving robot such as an AGV (Automated Guided Vehicle). The moving object 200 corresponds to the moving object 20 illustrated in FIG. 1.

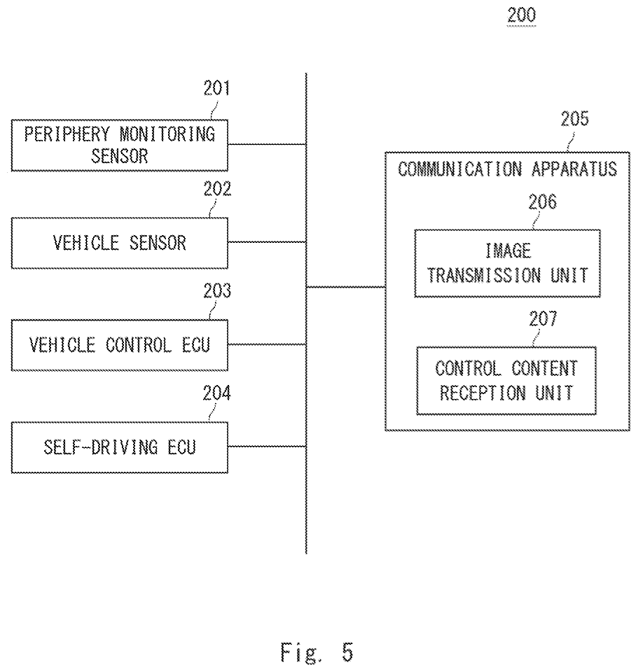

FIG. 5 illustrates a configuration example of the moving object 200. The moving object 200 includes a periphery monitoring sensor 201, a vehicle sensor 202, a vehicle control ECU (Electric Control Unit) 203, a self-driving ECU 204, and a communication apparatus 205. In the moving object 200, the components are configured to be communicable with each other via an in-vehicle LAN (Local Area Network), a CAN (Controller Area Network), or the like.

The periphery monitoring sensor 201 is a sensor that monitors a peripheral situation of the moving object 200. The periphery monitoring sensor 201 includes, for example, a camera, a radar, and a LiDAR (Light Detection and Ranging). The periphery monitoring sensor 201 may include, for example, a plurality of cameras that images the front, the rear, the right side, and the left side of the vehicle. The periphery monitoring sensor 201 may include a camera that images the inside of the moving object 200.

The vehicle sensor 202 is a sensor for detecting various states of the moving object 200. The vehicle sensor 202 includes, for example, sensors such as a speed sensor that detects a vehicle speed, a steering sensor that detects a steering angle, an accelerator position sensor that detects a position of an accelerator pedal, and a brake pedal force sensor that detects the amount of depression of a brake pedal.

The vehicle control ECU 203 is an electronic control apparatus that executes a traveling control of the moving object 200. In general, the electronic control apparatus includes a processor, a memory, an I/O (Input/Output), and a bus for connecting the components to each other. The vehicle control ECU 203 executes various controls such as a control of the amount of fuel consumption, a control of an engine ignition timing, and a control of the amount of power steering assist based on sensor information output from the vehicle sensor 202.

The self-driving ECU 204 is an electronic control apparatus that controls the self-driving of the moving object 200. The self-driving ECU 204 acquires the sensor information from the periphery monitoring sensor 201 and the vehicle sensor 202, and controls the self-driving of the moving object 200 based on the acquired sensor information.

The communication apparatus 205 is configured as an apparatus that executes wireless communication between the moving object 200 and the network 150 (refer to FIG. 4). The communication apparatus 205 includes an antenna for wireless communication, a transmitter, and a receiver as a hardware configuration. In addition, the communication apparatus 205 includes a processor, a memory, an I/O, and a bus for connecting the components to each other. A function of each of the units in the communication apparatus 205 is executed, for example, by the processor executing a control program stored in the memory.

The communication apparatus 205 includes an image transmission unit 206 and a control content reception unit 207. The image transmission unit 206 acquires a camera image acquired from the periphery monitoring sensor 201, and transmits the acquired camera image (image data) to the remote monitoring apparatus 110 via the network 150. The communication apparatus 205 may include another transmission unit that acquires the sensor information such as vehicle speed information from the vehicle sensor 202 and transmits the acquired sensor information to the remote monitoring apparatus 110 via the network 150.

The control content reception unit 207 receives the information regarding the control of the moving object 200 from the remote monitoring apparatus 110 via the network 150. The control content reception unit 207 receives, for example, control information representing a control content (for example, a control command) for self-driving that is executed in the moving object 200 from the remote monitoring apparatus 110. The control content includes, for example, “stop”, “passing”, “slow down”, and “departure”. The control content reception unit 207 may receive information such as a parameter set to the self-driving ECU 204 from the remote monitoring apparatus 110. The control content reception unit 207 transmits the received information to the self-driving ECU 204 via the in-vehicle LAN or the like. The self-driving ECU 204 controls the traveling of the moving object 200 according to the received control content. In addition, the self-driving ECU 204 executes the self-driving of the moving object 200 using the received parameter or the like.

The control content reception unit 207 may receive remote control information that is information for remotely controlling the moving object 200 from the remote monitoring apparatus 110. The remote control information includes information representing the accelerator position, the operation amount of the steering wheel, the amount of depression of the brake pedal, and the like. When the remote control information is received, the control content reception unit 207 transmits the received remote control information to the vehicle control ECU 203 via the in-vehicle LAN or the like. The vehicle control ECU 203 controls the moving object 200 based on the received remote control information.

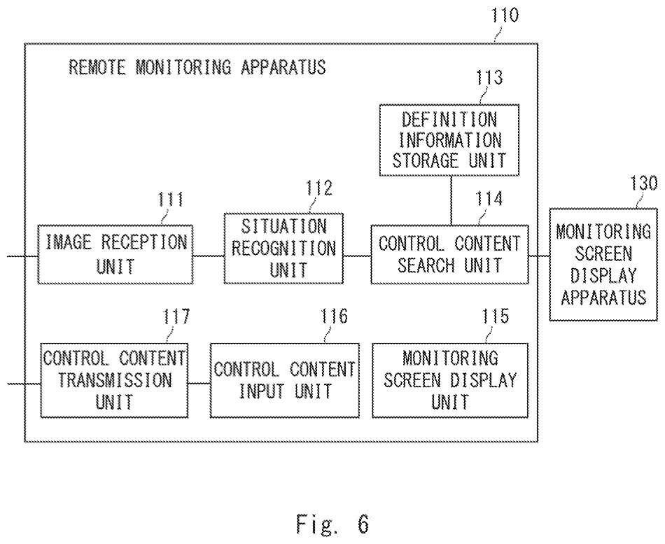

FIG. 6 illustrates a configuration example of the remote monitoring apparatus 110. The remote monitoring apparatus 110 includes an image reception unit 111, a situation recognition unit 112, a definition information storage unit 113, a control content search unit 114, a monitoring screen display unit 115, a control content input unit 116, and a control content transmission unit 117. The image reception unit 111 receives the image transmitted from the image transmission unit 206 of the moving object 200 via the network 150 (refer to FIG. 4). The image reception unit 111 receives, for example images of the front, the rear, the right side, and the left side of the moving object. The remote monitoring apparatus 110 may include another reception unit that receives the sensor information acquired by the vehicle sensor 202 from the moving object 200. The image reception unit 111 corresponds to the image reception means 31 illustrated in FIG. 2.

The situation recognition unit (situation recognition means) 112 recognizes a situation of the moving object 200 using the image received from the image reception unit 111. For example, the situation recognition unit 112 executes image analysis on the image received from the moving object 200, and recognizes the situation of the moving object 200 based on the result of the image analysis. The situation recognition unit 112 recognizes a situation that requires the assist of the monitoring person in the self-driving of the moving object 200. The situation recognition unit 112 outputs the recognized situation to the control content search unit 114 as information regarding the self-driving of the moving object 200.

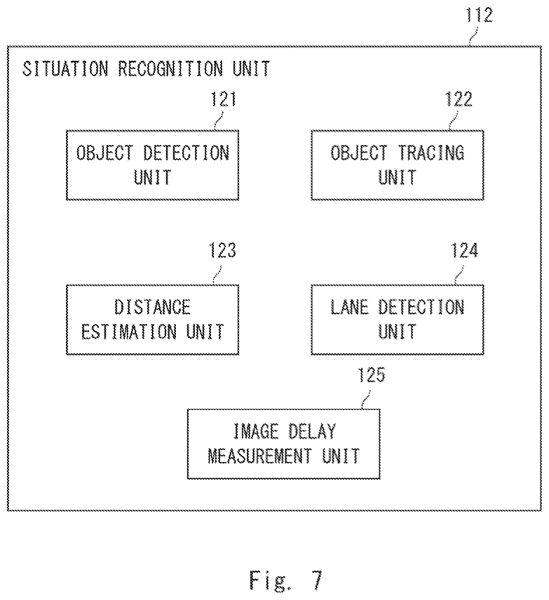

FIG. 7 illustrates a configuration example of the situation recognition unit 112. The situation recognition unit 112 includes an object detection unit 121, an object tracing unit 122, a distance estimation unit 123, a lane detection unit 124, and an image delay measurement unit 125. The object detection unit 121 detects an object in the image. The object detection unit 121 detects, for example, an object such as a vehicle that travels in the same direction as the moving object 200, an oncoming vehicle, or a person. The object detection unit 121 may detect a crosswalk, a traffic signal, or the like.

The object tracing unit 122 traces the detected object in the image. The distance estimation unit 123 estimates a distance between the moving object 200 and the detected object. The distance estimation unit 123 analyzes, for example, the image received from the moving object 200 to estimate the distance. Alternatively, the distance estimation unit 123 may estimate the distance using the sensor information received from the moving object 200. For example, the distance estimation unit 123 may estimate the distance to the object using distance measurement result of the LiDAR. The lane detection unit 124 detects a lane that the moving object 200 is traveling, a lane adjacent to the lane, or the like. The image delay measurement unit 125 measures a delay time of the image transmitted from the moving object 200. The situation recognition unit 112 recognizes the situation of the moving object 200 using the information acquired from the object detection unit 121, the object tracing unit 122, the distance estimation unit 123, the lane detection unit 124, and the image delay measurement unit 125.

The situation recognition unit 112 recognizes that a stopped vehicle is present using the result of tracing the object in the object tracing unit 122, a change over time in the distance estimated by the distance estimation unit 123, and the like. For example, when N represents the number of frames in the image, X [m] represents a predetermined threshold, and the distance to the vehicle decreases by X [m] or more in N continuous frames, the situation recognition unit 112 recognizes that a stopped vehicle is present in the front. The situation recognition unit 112 determines whether the stopped vehicle is stopped on the traveling lane (the same lane as the lane that the moving object 200 is traveling) or on another lane different from the traveling lane based on the position of the stopped vehicle and the detection result of the lane by the lane detection unit 124.

In addition, the situation recognition unit 112 recognizes the bulging of a walker to the traveling lane, for example, based on the result of tracing an object representing a person traced by the object tracing unit 122 and the detection result of the lane by the lane detection unit 124. When the object detection unit 121 detects a crosswalk, the moving object 200 is stopped in front of the crosswalk, and a walker is crossing the crosswalk, the situation recognition unit 112 recognizes that the situation of the moving object 200 is a situation where the moving object 200 is about to departure after being stopped at the crosswalk. The situation recognition unit 112 compares the delay time measured by the image delay measurement unit 125 to a predetermined threshold (for example, 200 ms). When the delay time is the threshold or more, the situation recognition unit 112 recognizes that the image distribution is high latency.

In the above description, the example in which the situation recognition unit 112 executes image analysis on the image received from the moving object 200 to recognize the situation of the moving object 200 is described. However, the example embodiment is not limited to this example. The situation recognition unit 112 may recognize the situation of the moving object 200, for example, using position information of the moving object 200 and information of a route along which the moving object 200 travels. In addition, the situation recognition unit 112 may recognize the situation of the moving object 200 using the information such as a vehicle speed received from the moving object 200.

Referring to FIG. 6 again, the definition information storage unit (definition information storage means) 113 stores definition information that defines a correspondence between the situation of the moving object 200 and the control contents that are applicable to the moving object 200 in each of the situations. The control content search unit 114 searches the definition information storage unit 113 and acquires one or more control contents corresponding to the situations recognized by the situation recognition unit 112 as control content candidates. The control content search unit 114 corresponds to the candidate acquisition means 32 illustrated in FIG. 2. The definition information storage unit 113 only needs to be accessible from the control content search unit 114 and does not need to be a part of the remote monitoring apparatus 110. For example, the definition information storage unit 113 may be a cloud storage, and the control content search unit 114 may access the definition information storage unit 113 via a network.

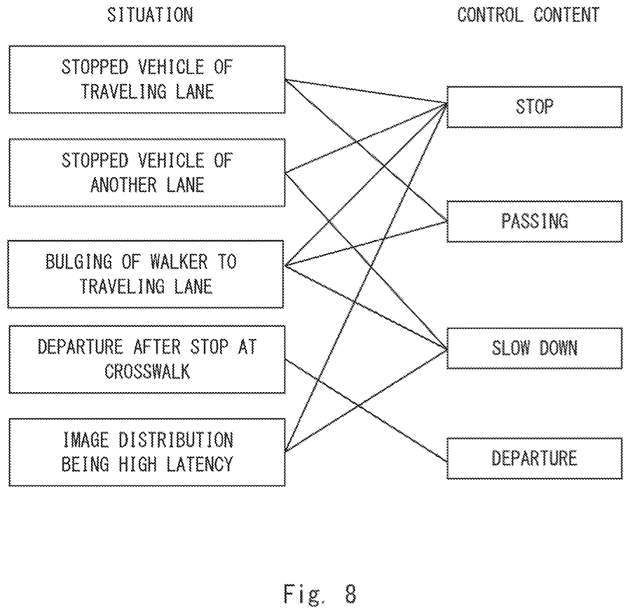

FIG. 8 illustrates an example of the correspondence between the situation of the moving object 200 and the control contents, the correspondence being defined using the definition information. Here, five situations are assumed as examples of the situation of the moving object 200. “Stopped vehicle of traveling lane” represents a situation where a stopped vehicle is present on the traveling lane of the moving object 200. “Stopped vehicle of another lane” represents a situation where a stopped vehicle is present on another lane (for example, an oncoming lane) different from the traveling lane. “Bulging of walker to traveling lane” represents a situation where a walker bulges out to the traveling lane of the moving object 200. “Departure after stop at crosswalk” represents a situation where the moving object 200 is stopped in front of a crosswalk and waits for an instruction for departure. “Image distribution being high latency” represents a situation where the delay time from the image transmission in the moving object 200 to the image reception in the remote monitoring apparatus 110 is long.

In addition, here, four control contents are assumed as the control content for the self-driving of the moving object 200. “Stop” represents that the moving object 200 that is traveling temporarily stops. “Passing” represents that the moving object 200 avoids a front object, returns to the traveling lane, and travels. “Slow down” represents that the moving object 200 that is traveling slows down and travels at a low speed. “Departure” represents that the moving object 200 that is stopped starts to travel.

In FIG. 8 a line that connects “situation” and “control content” represents that there is a correspondence therebetween. For example, in FIG. 8, the situation “stopped vehicle of traveling lane” is associated with the control contents “stop” and “passing”. In addition, the situation “stopped vehicle of another lane” is associated with the control contents “stop” and “slow down”. For example, when the situation recognized by the situation recognition unit 112 is “stopped vehicle of traveling lane”, the control content search unit 114 acquires the control contents “stop” and “passing” as control content candidates. For example, when the situation recognized by the situation recognition unit 112 is “stopped vehicle of another lane”, the control content search unit 114 acquires the control contents “stop” and “slow down” as control content candidates.

The monitoring screen display unit 115 causes the monitoring screen display apparatus 130 to display the monitoring screen used for monitoring the moving object 200. The monitoring screen includes, for example, the image received by the image reception unit 111, the situation recognized by the situation recognition unit 112, and the control content searched by the control content search unit 114. The monitoring screen display apparatus 130 displays the situation recognized by the situation recognition unit 112 and the control content searched by the control content search unit 114 at positions that do not interfere with the monitoring of the moving object 200 on the monitoring screen. The monitoring screen display apparatus 130 may display the information such as a vehicle speed transmitted from the moving object 200 on the monitoring screen.

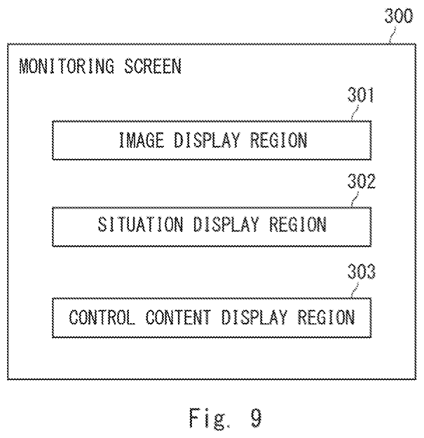

FIG. 9 illustrates an example of the monitoring screen. A monitoring screen 300 includes an image display region 301, a situation display region 302, and a control content display region 303. The monitoring screen display apparatus 130 displays the image received from the image reception unit 111 in the image display region 301. When the image reception unit 111 receives a plurality of images from the moving object 200, the monitoring screen 300 may include a plurality of image display regions 301. In this case, the monitoring screen display apparatus 130 may display each of the images in each of the image display regions 301. The monitoring screen display apparatus 130 may display an image selected by the monitoring person, for example, an image of the front of a vehicle among the plurality of images in the image display region 301.

The monitoring screen display apparatus 130 displays the situation recognized by the situation recognition unit 112 in the situation display region 302. The monitoring screen display apparatus 130 displays the control content acquired from the control content search unit 114 in the control content display region 303. The monitoring person can understand which situation occurs in the moving object 200 by referring to the situation displayed in the situation display region 302. In addition, the monitoring person can understand which control content can be selected in the situation occurring in the moving object 200 by referring to the control content displayed in the control content display region 303. The monitoring screen display apparatus 130 may surround a target such as another vehicle or a walker causing the recognized situation with a figure such as a rectangle in the image display region 301. In this case, the monitoring person can understand the position or the like of the target causing the situation in addition to the situation occurring in the moving object 200 on the screen.

Referring to FIG. 6 again, the control content input unit 116 receives an input of the control content. The monitoring person determines the situation of the periphery of the moving object 200 by seeing the image displayed in the image display region 301 (refer to FIG. 9). The monitoring person uses the control content input unit 116 to select the control content to be transmitted to the moving object 200 from the one or more control contents selected by the control content display region 303. The monitoring person can select the control content of the moving object 200 from the monitoring screen 300, for example, using a pointing device such as a mouse. Alternatively, when the monitoring screen display apparatus 130 includes a touch panel, the monitoring person can select the control content of the moving object 200 on the touch panel that displays the monitoring screen 300.

The control content input unit 116 notifies the control content selected by the monitoring person to the control content transmission unit 117. The control content transmission unit 117 transmits a control signal representing the control content selected by the monitoring person to the moving object 200 via the network 150 (refer to FIG. 4). The control content reception unit 207 (refer to FIG. 5) of the moving object 200 receives the control signal from the remote monitoring apparatus 110. In the moving object 200, the automatic control ECU 204 controls the moving object 200 according to the control content represented by the received control signal.

Here, a time limit may be provided for the selection of the control content of the monitoring person. For example, when a stopped vehicle is present in front of the moving object 200, if the moving object 200 continuously travels, the moving object 200 collides with the front stopped vehicle. The time limit can be defined as a period of time until the moving object 200 can be stopped in front of the stopped vehicle. The situation recognition unit 112 estimates a period of time taken until the moving object 200 collides with the front object based on a change over time in the distance between the moving object 200 and the front object. The monitoring screen display unit 115 may cause the monitoring screen display apparatus 130 to display the remaining time of the time limit. When the remaining time is zero, that is, when the control content is not selected within the time limit, the control content transmission unit 117 may automatically transmit a predetermined control content, for example, a control signal representing “stop” among the control contents acquired by the control content search unit 114.

The remote monitoring apparatus 110 may further include a control unit (remote control unit) configured to transmit information for remotely controlling the moving object 200 to the moving object 200 via the network 150. The remote control unit includes facilities such as a steering wheel, an accelerator pedal, and a brake pedal for remotely operating a vehicle. The monitoring person (remote driver) can operate the steering wheel and the like while seeing the image displayed by the monitoring screen display apparatus 130. The remote control unit transmits information representing the operation amount of the steering wheel and the like to the moving object 200.

Next, an operation procedure will be described. FIG. 10 illustrates an operation procedure (remote monitoring method) of the remote monitoring apparatus 110. The image reception unit 111 receives an image from the moving object 200 (Step B1). The situation recognition unit 112 recognizes a situation of the moving object 200 using the image received in Step B1 (Step B2). The situation recognition unit 112 executes image analysis on, for example, the image transmitted from the moving object 200 in Step B2, and recognizes a situation that requires the assist of the monitoring person in the self-driving of the moving object 200.

The control content search unit 114 acquires a control content corresponding to the situation recognized in Step B2 by referring to the definition information storage unit 113 (Step B3). The monitoring screen display unit 115 causes the monitoring screen display apparatus 130 to display a monitoring screen including the image received in Step B1, the situation recognized in Step B2, and the control content acquired in Step B3 (Step B4).

The monitoring person can understand the situation occurring in the moving object 200 and the control content corresponding to the situation by referring to the monitoring screen. The monitoring person recognizes the situation of the periphery of the moving object 200 to determine the control content by seeing the image displayed on the monitoring screen. When the monitoring person selects the control content, the control content input unit 116 notifies the selected control content to the control content transmission unit 117. The control content transmission unit 117 transmits a control signal representing the control content selected by the monitoring person to the moving object 200 (Step B5). The moving object 200 controls the operation of the moving object 200 according to the control content that is represented by the control signal received from the remote monitoring apparatus 110.

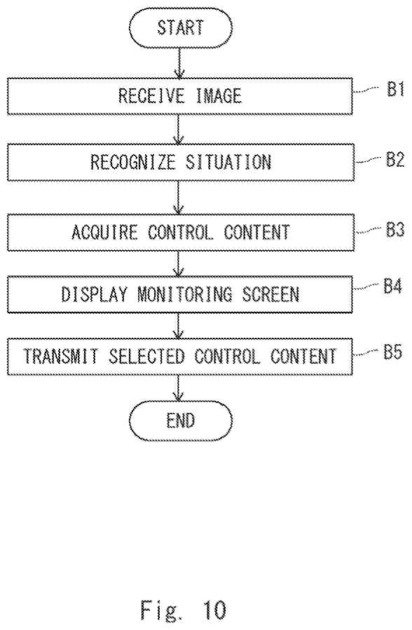

FIG. 11 illustrates a first display example of the monitoring screen. In this example, the monitoring screen 300 includes four image display regions 301F, 301B, 301R, and 301L. The image display region 301F is a region where an image of the front of the moving object 200 is displayed. The image display region 301B is a region where an image of the rear of the moving object 200 is displayed. The image display region 301R is a region where an image of the right side of the moving object 200 is displayed. The image display region 301L is a region where an image of the left side of the moving object 200 is displayed.

For example, the situation recognition unit 112 analyzes the image of the front received from the moving object 200, and recognizes that a stopped vehicle is present on the traveling lane. In the example illustrated in FIG. 11, the monitoring screen display apparatus 130 displays a mark for calling attraction and a character string “FRONT CAR STOP” corresponding to “stopped vehicle of traveling lane” in the situation display region 302. In the example of FIG. 11, the situation display region 302 is disposed at a position not overlapping the image display region 301. The monitoring person can understand the stopped vehicle is present on the traveling lane of the moving object 200 by referring to the character string displayed in the situation display region 302. The monitoring screen display apparatus 130 may surround the stopped vehicle displayed in the image display region 301 with a figure such as a rectangle. In this case, the monitoring person can understand where the stopped vehicle is stopped.

The control content search unit 114 acquires the control content “stop” and “passing” corresponding to the recognized situation “stopped vehicle in traveling lane” by referring to the definition information storage unit 113. The monitoring screen display apparatus 130 displays a button for selecting “stop” and a button for selecting “passing” in the control content display region 303 using a pop-up. The monitoring person can understand that “stop” or “passing” can be selected for the situation “stopped vehicle of traveling lane” by seeing the control content display region 303.

The monitoring person grasps the state of the moving object 200 by referring the images displayed in the image display regions 301F, 301B, 301R, and 301L. When the monitoring person determines that the moving object can pass the stopped vehicle, the monitoring person selects “Passing” displayed in the control content display region 303 using the control content input unit 116. The control content input unit 116 notifies “passing” selected by the monitoring person to the control content transmission unit 117. The control content transmission unit 117 transmits a control signal representing “passing” to the moving object 200. The moving object 200 passes the stopped vehicle according to the received control signal without stopping. The monitoring screen display apparatus 130 continuously displays the image received from the moving object 200 in each of the image display regions while the moving object 200 is passing the stopped vehicle. In addition, the monitoring screen display apparatus 130 continues the display in the situation display region 302 and the control content display region 303. When the moving object 200 completes passing, the monitoring screen display apparatus 130 cancels the display of the situation display region 302 and the control content display region 303. When the monitoring person selects “Stop”, a control signal representing stop is transmitted to the moving object 200, and the moving object 200 stops in front of the stopped vehicle.

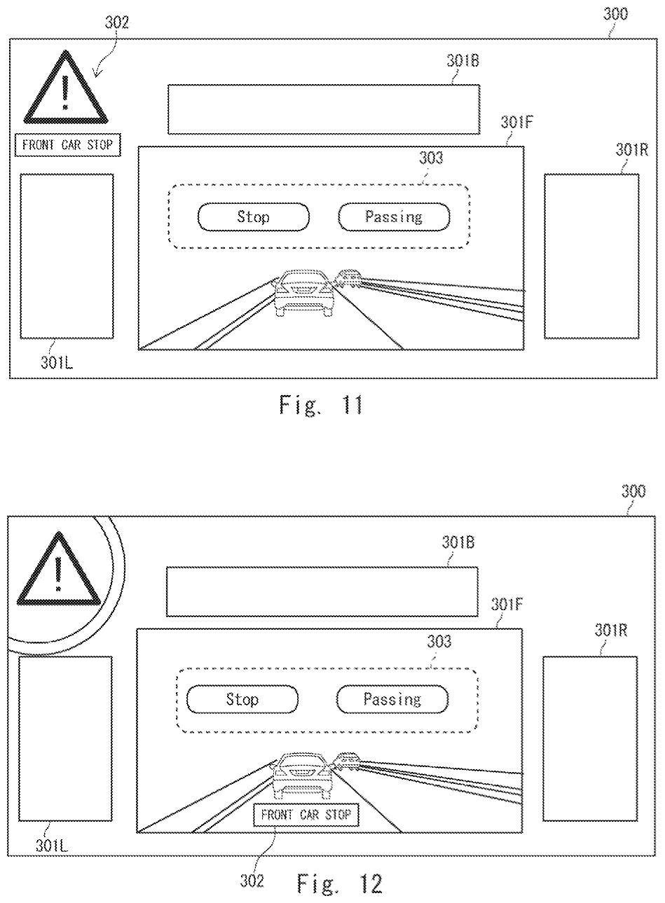

FIG. 12 illustrates a second display example of the monitoring screen. The second display example illustrated in FIG. 12 is different from the first display example illustrated in FIG. 11, in that the situation display region 302 is disposed inside the image display region 301F. In the second display example, the situation display region 302 is disposed adjacent to a region of the stopped vehicle in the image of the front displayed in the image display region 301F. In this case, the monitoring person can easily recognize the stopped vehicle.

FIG. 13 illustrates a third display example of the monitoring screen. The position of the situation display region 302 in the third display example illustrated in FIG. 13 is different from that in the second display example illustrated in FIG. 12. In the third display example, a button for selecting the control content displayed in the control content display region 303 includes an illustration. In the third display example, the situation display region 302 is disposed in a region outside of a road, for example, a region of sky in the image of the front displayed in the image display region 301F. In the image of the front displayed in the image display region 301F, an image of an object or the like on a road does not interfere with the situation display region 302.

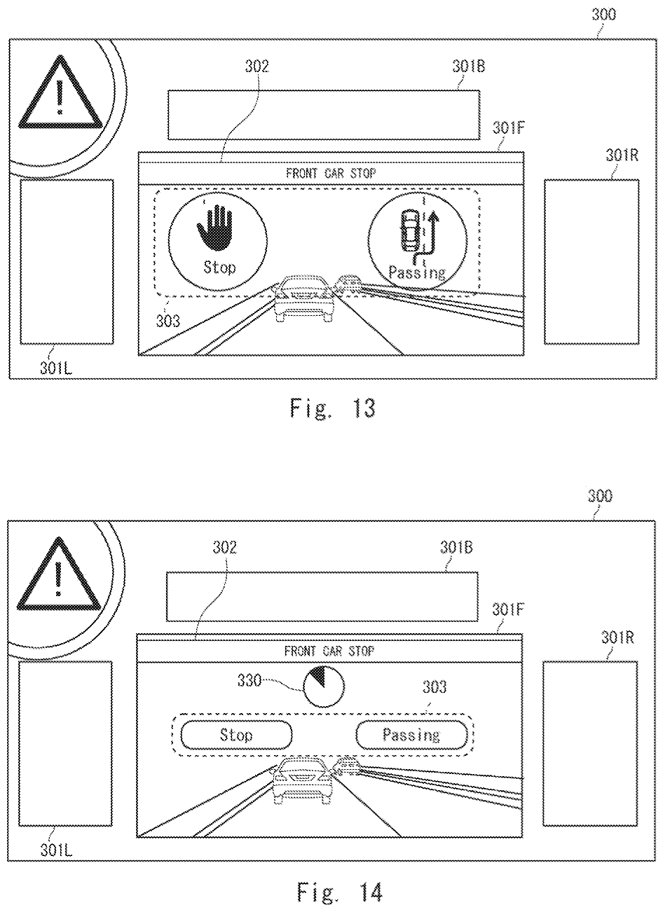

FIG. 14 illustrates a fourth display example of the monitoring screen. The fourth display example illustrated in FIG. 13 is different from the third display example illustrated in FIG. 13, in that the remaining time until “stop” is automatically selected is displayed on the monitoring screen 300. In the fourth display example, the remaining time is displayed using a circular progress bar 330. In this case, the monitoring person can visually recognize a period of time until “stop” is automatically selected. In FIG. 14, the remaining time is displayed by the circular progress bar. However, the example embodiment is not limited to this example. For example, the remaining time may be displayed by a horizontally long bar or by the number of seconds.

When a plurality of moving objects 200 to be monitored are present, the monitoring screen display apparatus 130 displays the monitoring screen 300 for each of the moving objects 200. The monitoring screen display apparatus 130 may divide, for example, the display screen into a plurality of regions such that the monitoring screens 300 of the moving objects 200 are displayed in the divided regions, respectively. Instead, a plurality of monitoring screen display apparatuses 130 may be used such that the monitoring screens 300 of the moving objects 200 are displayed by the monitoring screen display apparatuses 130, respectively.

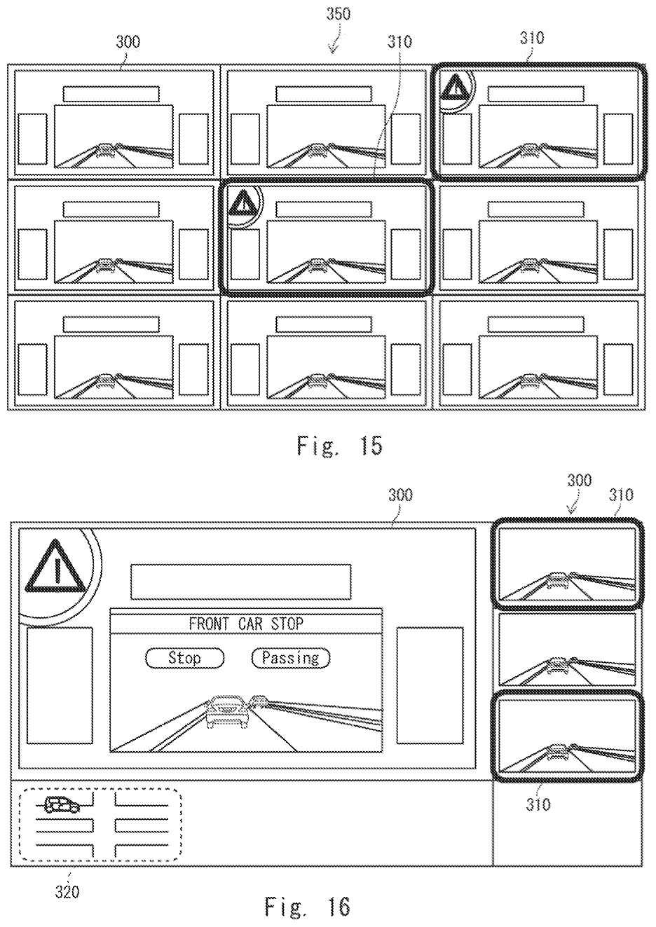

FIG. 15 illustrates a fifth display example of the monitoring screen. In the fifth display example illustrated in FIG. 15, a display screen 350 of the monitoring screen display apparatus 130 is divided into a plurality of regions, and the monitoring screen 300 is displayed in each of the divided regions. In FIG. 15, the display screen 350 is divided into 3×3 regions, and the monitoring screens 300 of the nine moving objects 200 in total are displayed. Among the plurality of moving objects 200, the monitoring screen 300 of a moving object where the situation recognized by the situation recognition unit 112 does not occur does not include the situation display region 302 and the control content display region 303.

The monitoring screen display apparatus 130 may highlight the display of the monitoring screen 300 of a moving object where the situation recognized by the situation recognition unit 112 occurs, that is, a moving object for which a countermeasure is required. In FIG. 15, the monitoring screen display apparatus 130 surrounds the monitoring screen 300 of the moving object for which a countermeasure is required with a frame 310. The frame 310 is displayed by a predetermined display color, for example, red. As a result, the monitoring person can easily recognize, for example, the moving object for which a countermeasure is required among the nine moving objects 200 in total. In addition, the monitoring screen 300 includes the control content display region 303. When countermeasures are required for a plurality of moving objects 200, the monitoring person can understand which control content can be selected for each of the moving objects 200. The monitoring screen display apparatus 130 does not need to display the monitoring screen 300 for the moving object where the situation recognized by the situation recognition unit 112 does not occur.

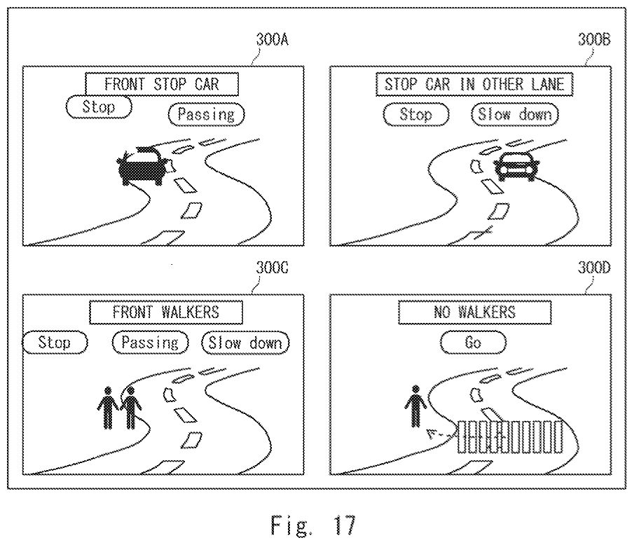

FIG. 16 illustrates a sixth display example of the monitoring screen. In the sixth display example illustrated in FIG. 16, the monitoring screen of the moving object selected by the monitoring person is enlarged and displayed. For example, in the fifth display example, the monitoring person selects one moving object 200. The monitoring screen display apparatus 130 displays the monitoring screen 300 of the selected moving object at a larger size than that of the monitoring screen 300 of the moving object that is not selected. In other words, the monitoring screen display apparatus 130 enlarges and displays the monitoring screen 300 of the selected moving object, and reduces and displays the monitoring screen 300 of the moving object that is not selected. The monitoring screen display apparatus 130 may enlarge and display the monitoring screen of the moving object where the situation recognized by the situation recognition unit 112 occurs.

The monitoring screen display apparatus 130 may display a part of a plurality of images selected by the monitoring person, for example, the image of the front of the moving object in the monitoring screen 300 that is reduced and displayed. When the situation recognized by the situation recognition unit 112 occurs in the moving object that is not selected, the monitoring screen display apparatus 130 may surround the corresponding monitoring screen 300 with the frame 310. The monitoring screen display apparatus 130 may display a list of situations having a high degree of risk among the situations occurring in the moving object. The degree of risk is defined in advance, for example, depending on the situations. For example, when the moving object departs after completion of the crossing of a walker, the possibility of an accident is determined to be low such that the degree of risk may be set to be low. For example, when a walker bulges out to the traveling lane, the possibility of an accident is determined to be high such that the degree of risk may be set to be high.

The sixth display example includes a position display region 320 representing the position of the selected moving object 200. In the position display region 320, the position of the moving object 200 is displayed on a map. The monitoring person can understand the position where the moving object 200 travels by referring the position display region 320.

FIG. 17 illustrates a display example of monitoring screens when different situations occur in a plurality of moving objects. Here, the remote monitoring apparatus 110 receives images from four moving objects 200. In FIG. 17, a monitoring screen 300A corresponds to a monitoring screen of a moving object A, and a monitoring screen 300B corresponds to a monitoring screen of a moving object B. A monitoring screen 300C corresponds to a monitoring screen of a moving object C, and a monitoring screen 300D corresponds to a monitoring screen of a moving object D.

The situation recognition unit 112 recognizes a situation where a stopped vehicle is present on the traveling lane for the moving object A. The control content search unit 114 acquires the control contents “stop” and “passing” corresponding to the recognized situation. In this case, the monitoring screen display apparatus 130 displays “FRONT CAR STOP” on the monitoring screen 300A. In addition, the monitoring screen display apparatus 130 displays the control contents “Stop” and “Passing” corresponding to “FRONT CAR STOP” on the monitoring screen 300A.

The situation recognition unit 112 recognizes a situation where a stopped vehicle is present on another lane different from the traveling lane for the moving object B. The control content search unit 114 acquires the control contents “stop” and “slow down” corresponding to the recognized situation. In this case, the monitoring screen display apparatus 130 displays “STOP CAR IN OTHER LANE” on the monitoring screen 300B. In addition, the monitoring screen display apparatus 130 displays the control contents “Stop” and “Slow down” corresponding to “STOP CAR IN OTHER LANE” on the monitoring screen 300B.

The situation recognition unit 112 recognizes a situation where a walker bulges out to the traveling lane for the moving object C. The control content search unit 114 acquires the control contents “stop”, “passing”, and “slow down” corresponding to the recognized situation. In this case, the monitoring screen display apparatus 130 displays “FRONT WALKERS” on the monitoring screen 300C. In addition, the monitoring screen display apparatus 130 displays the control contents “Stop”, “Passing”, and “Slow down” corresponding to “FRONT WALKERS” on the monitoring screen 300C.

The situation recognition unit 112 recognizes a situation where the moving object D is stopped in front of a crosswalk and waits for an instruction for departure. The control content search unit 114 acquires the control content “departure” corresponding to the recognized situation. In this case, the monitoring screen display apparatus 130 displays “NO WALKERS” on the monitoring screen 300D. In addition, the monitoring screen display apparatus 130 displays the control content “departure (Go)” corresponding to “NO WALKERS” on the monitoring screen 300C.

The monitoring person can understand that stop and passing can be selected for the moving object A by seeing the screen illustrated in FIG. 17. In addition, the monitoring person can understand that stop and slow down can be selected for the moving object B. The monitoring person can understand that stop, passing, slow down can be selected for the moving object C. The monitoring person can understand that departure can be selected for the moving object D. This way, even when situations that require countermeasures occur in a plurality of moving objects 200, the monitoring person can understand which control content can be selected for each of the moving objects 200. Therefore, the monitoring person does not need to grasp in advance which countermeasure can be selected against various situations that occur.

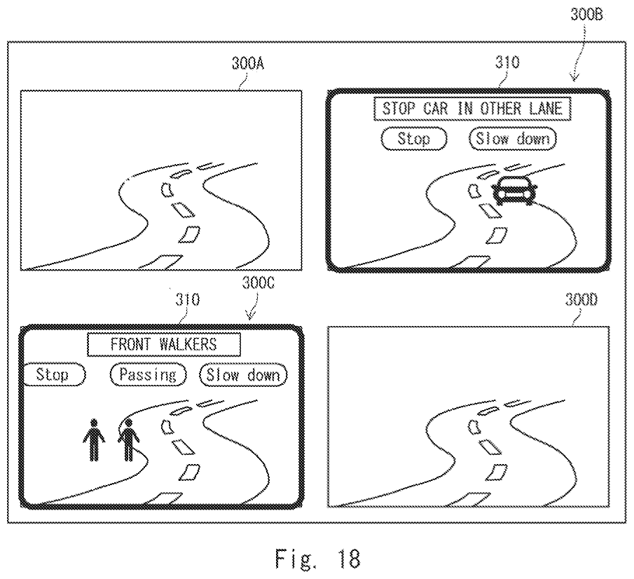

FIG. 18 illustrates another display example of monitoring screens when different situations occur in a plurality of moving objects. In the display example illustrated in FIG. 18, situations recognized by the situation recognition unit 112 occur in the moving object B and the moving object C. On the other hand, situations recognized by the situation recognition unit 112 do not occur in the moving object A and the moving object D. The monitoring screen display apparatus 130 displays the monitoring screen 300B and the monitoring screen 300C surrounded with a red frame 310. By highlighting the display of a monitoring screen of a moving object where a situation that requires a target occurs using the frame 310 or the like, the monitoring person can easily determine which countermeasure may be taken for which moving object among a plurality of moving objects 200.

In the example embodiment, the situation recognition unit 112 recognizes the situations of the moving object 200. The control content search unit 114 acquires a control content corresponding to the recognized situation as control content candidates. The monitoring screen display unit 115 causes the monitoring screen display apparatus 130 to display the image of the moving object 200, the recognized situation of the moving object 200, and the control content candidates. In the example embodiment, the monitoring person can select a control content to be applied to the moving object 200 from the control content candidates displayed on the monitoring screen. Therefore, even when the monitoring person does not grasp in advance which countermeasure can be taken against various situations occurring in a self-driving vehicle, the monitoring person can rapidly take a countermeasure against an occurred event.

In particular, when one monitoring person monitors a plurality of moving objects, the monitoring person is required to closely watch monitoring screens of all of the moving objects and to take countermeasures against situations occurring in the moving objects. In the example embodiment, when situations that require countermeasures occur in some moving objects, the situations recognized by the situation recognition unit 112 are displayed on the monitoring screens. The monitoring person does not need to closely watch the monitoring screens of all of the moving objects at all times, and only needs to closely watch the monitoring screens of the moving objects where the situations that require countermeasures occur. Therefore, a load on the monitoring person can be reduced. In addition, in the example embodiment, control content candidates corresponding to the occurred situation are displayed on the monitoring screen of each of the moving objects. The monitoring person can select a control content to be applied to each of the moving objects from the control content candidates. As a result, a period of time until the monitoring person takes a countermeasure for each of moving objects can be reduced, and the monitoring person can smoothly execute remote monitoring of a plurality of moving objects.

In the above-described example embodiment, the example where the remote monitoring apparatus 110 executes image analysis on the image acquired from the moving object 200 to recognize the situation of the moving object is described. However, the present disclosure is not limited to this example. For example, the remote monitoring apparatus 110 may acquire information regarding the self-driving of the moving object 200 from the self-driving ECU 204 (refer to FIG. 5) of the moving object 200. In this case, the control content search unit 114 may acquire control content candidates based on the information regarding the self-driving of the moving object 200 acquired from the moving object 200.

In the above-described example embodiment, the example where the red frame 310 (refer to FIG. 15 and the like) is used to highlight the monitoring screen of the moving object 200 for which a countermeasure is required is described. However, the present disclosure is not limited to this example. The display color of the frame 310 is not limited to red and may be blue or green. In addition, the monitoring screen display apparatus 130 may highlight the monitoring screen of the moving object 200 that requires a countermeasure by blinking the frame 310.

Instead of or in addition to the above-described configurations, the monitoring screen display apparatus 130 may highlight the monitoring screen of the moving object that require a countermeasure by changing the brightness of display between a monitoring screen of a moving object for which a countermeasure is required and a monitoring screen of a moving object for which a countermeasure is not required. For example, the monitoring screen display apparatus 130 may decrease the brightness of a monitoring screen of a moving object for which a countermeasure is not required such that a monitoring screen of a moving object for which a countermeasure is required is displayed to be brighter.

The monitoring screen display apparatus 130 may change the aspect of highlight display depending on the degree of risk of a situation occurred in a moving object. For example, the monitoring screen display apparatus 130 may blink the red frame 310 that surrounds a monitoring screen of a moving object where a situation having a highest degree of risk occurs. The monitoring screen display apparatus 130 may surround a monitoring screen of a moving object where a situation having a low degree of risk occurs with a frame with another color different from red, for example, with a blue frame 310. In this case, even when situations having different degrees of risk occur in a plurality of moving objects, the monitoring person can easily recognize a moving object where a situation having a high degree of risk occurs.

In the above-described example embodiment, the example where the situation recognition unit 112 mainly analyzes the image of the front of the moving object 200 to recognize that a specific situation occurs in the front of the moving object 200 is described. However, the present disclosure is not limited to this example. The situation recognition unit 112 may recognize that a specific situation occurs, for example, using the images of the right side, the left side, and the rear of the moving object 200. For example, the situation recognition unit 112 analyzes the image of the rear to recognize a situation where an emergency vehicle such as an ambulance approaches from the rear. In this case, the control content search unit 114 may acquire “slow down” and “stop” as control contents for the situation. In this case, the monitoring person can instruct the moving object 200 to execute slow down or stop for the situation where the emergency vehicle approaches the moving object 200 from the rear.

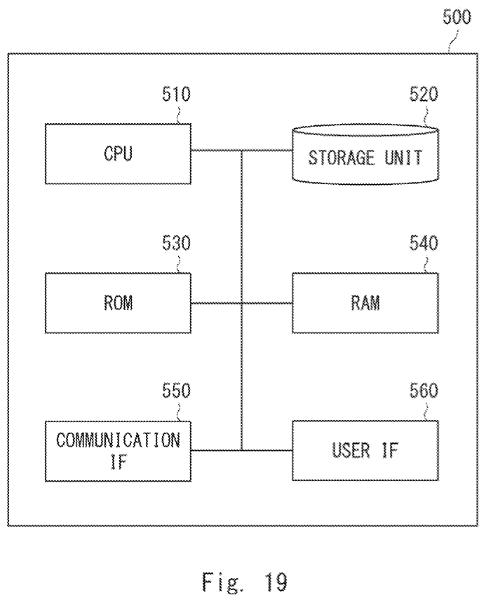

In the present disclosure, the remote monitoring apparatus 110 can be formed as a computer apparatus. FIG. 19 illustrates a configuration example of a computer apparatus that can be used for the remote monitoring apparatus 110. The computer apparatus 500 includes a control unit (CPU: Central Processing Unit) 510, a storage unit 520, a ROM (Read Only Memory) 530, a RAM (Random Access Memory) 540, a communication interface (IF: Interface) 550, and a user interface 560.

The communication interface 550 is an interface for connecting the computer apparatus 500 to a communication network through wired communication means or wireless communication means. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 does not necessarily have to be a part of the computer apparatus 500, and may be an external storage device or a cloud storage connected to the computer apparatus 500 through a network.

The ROM 530 is a nonvolatile storage device. For example, a semiconductor storage device such as a flash memory having relatively small capacity is used for the ROM 530. Programs executed by the CPU 510 can be stored in the storage unit 520 or the ROM 530. The storage unit 520 or the ROM 530 stores various programs for realizing the functions of each unit in the remote monitoring apparatus 110.

The above-described program can be stored and provided to the computer apparatus 500 by using any type of non-transitory computer readable media. The non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. As the RAM 540, various types of semiconductor memory devices such as a DRAM (Dynamic Random Access Memory) or an SRAM (Static Random Access Memory) can be used. The RAM 540 can be used as an internal buffer for temporarily storing data and the like. The CPU 510 expands (i.e., loads) a program stored in the storage unit 520 or the ROM 530 in the RAM 540, and executes the expanded (i.e., loaded) program. The CPU 510 executes the program, and thus the functions of the respective units in the remote monitoring apparatus 110 may be realized. The CPU 510 may include internal buffers that can temporarily store data.

Although the example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, the whole or part of the example embodiments disclosed above can be described as, but not limited to, the following supplementary notes.

### [Supplementary Note 1]

A remote monitoring system comprising:
one or more moving objects configured to be capable of autonomous driving; and
a remote monitoring apparatus that is used for monitoring the moving objects,
wherein the remote monitoring apparatus comprises
image reception means for receiving image data obtained by imaging an outside of the moving object from the moving object,
candidate acquisition means for acquiring control content candidates including one or more control contents of autonomous driving based on information regarding autonomous driving in the moving object,
monitoring screen display means for causing a display apparatus to display a monitoring screen including a region where the image data is displayed and a region where the control content candidates are displayed, and
control content transmission means for transmitting, when one control content is selected from the control content candidates, a control signal representing the selected control content to the moving object, and
the moving object receives the control signal transmitted from the control content transmission means, and executes autonomous driving according to the control content represented by the received control signal.

### [Supplementary Note 2]

The remote monitoring system according to Supplementary note 1, further comprising situation recognition means for recognizing a situation of the moving object based on the image data and outputting the recognized situation to the candidate acquisition means as the information regarding autonomous driving in the moving object,
wherein the candidate acquisition means acquires the control content candidates based on the situation recognized by the situation recognition means.

### [Supplementary Note 3]

The remote monitoring system according to Supplementary note 2, further comprising definition information storage means for storing definition information that defines a correspondence between the situation recognized by the situation recognition means and one or more control contents of autonomous driving that are selectable in the situation,
wherein the candidate acquisition means acquires one or more control contents of autonomous driving corresponding to the situation recognized by the situation recognition means as the control content candidates by referring to the definition information storage means.

### [Supplementary Note 4]

The remote monitoring system according to Supplementary note 2 or 3,
wherein the monitoring screen further includes a region where the situation is displayed.

### [Supplementary Note 5]

The remote monitoring system according to any one of Supplementary notes 1 to 4,
wherein the remote monitoring system includes a plurality of moving objects, and
the monitoring screen display means causes the display apparatus to display the monitoring screens of the plurality of moving objects.

### [Supplementary Note 6]

The remote monitoring system according to any one of Supplementary notes 1 to 5,
wherein when the control content is not selected within a time limit, the control content transmission means transmits a control signal for stopping the moving object to the moving object.

### [Supplementary Note 7]

The remote monitoring system according to Supplementary note 6,
wherein the monitoring screen display means causes the display apparatus to display a remaining time of the time limit.

### [Supplementary Note 8]

A remote monitoring apparatus comprising:
image reception means for receiving, from a moving object configured to be capable of autonomous driving, image data obtained by imaging an outside of the moving object;
candidate acquisition means for acquiring control content candidates including one or more control contents of autonomous driving based on information regarding autonomous driving in the moving object;
monitoring screen display means for causing a display apparatus to display a monitoring screen including a region where the image data is displayed and a region where the control content candidates are displayed; and
control content transmission means for transmitting, when one control content is selected from the control content candidates, a control signal representing the selected control content to the moving object.

### [Supplementary Note 9]

The remote monitoring apparatus according to Supplementary note 8, further comprising situation recognition means for recognizing a situation of the moving object based on the image data and outputting the recognized situation to the candidate acquisition means as the information regarding autonomous driving in the moving object,
wherein the candidate acquisition means acquires the control content candidates based on the situation recognized by the situation recognition means.

### [Supplementary Note 10]

The remote monitoring apparatus according to Supplementary note 9, further comprising definition information storage means for storing definition information that defines a correspondence between the situation recognized by the situation recognition means and one or more control contents of autonomous driving that are selectable in the situation,
wherein the candidate acquisition means acquires one or more control contents of autonomous driving corresponding to the situation recognized by the situation recognition means as the control content candidates by referring to the definition information storage means.

### [Supplementary Note 11]

The remote monitoring apparatus according to Supplementary note 9 or 10,
wherein the monitoring screen further includes a region where the situation is displayed.

### [Supplementary Note 12]

The remote monitoring apparatus according to any one of Supplementary notes 8 to 11,
wherein the image reception means receives image data from a plurality of moving objects, and
the monitoring screen display means causes the display apparatus to display the monitoring screens of the plurality of moving objects.

### [Supplementary Note 13]

The remote monitoring apparatus according to any one of Supplementary notes 8 to 12,
wherein when the control content is not selected within a time limit, the control content transmission means transmits a control signal for stopping the moving object to the moving object.

### [Supplementary Note 14]

The remote monitoring apparatus according to Supplementary note 13,
wherein the monitoring screen display means causes the display apparatus to display a remaining time of the time limit.

### [Supplementary Note 15]

A remote monitoring method comprising:
receiving, from a moving object configured to be capable of self-driving, image data obtained by imaging an outside of the moving object;
acquiring control content candidates including one or more control contents of autonomous driving based on information regarding autonomous driving in the moving object;
causing a display apparatus to display a monitoring screen including a region where the image data is displayed and a region where the control content candidates are displayed; and
transmitting, when one control content is selected from the control content candidates, a control signal representing the selected control content to the moving object.

### [Supplementary Note 16]

The remote monitoring method according to Supplementary note 15, further comprising recognizing a situation of the moving object based on the image data,
wherein in the acquisition of the control content candidates, the recognized situation is used as the information regarding autonomous driving in the moving object, and the control content candidates are acquired based on the recognized situation.

### [Supplementary Note 17]

The remote monitoring method according to Supplementary note 16,
wherein in the acquisition of the control content candidates, one or more control contents of autonomous driving corresponding to the recognized situation are acquired as the control content candidates by referring to definition information that defines a correspondence between the situation of the moving object and one or more control contents of autonomous driving that are selectable in the situation.

### [Supplementary Note 18]

The remote monitoring method according to Supplementary note 16 or 17,
wherein in the display of the monitoring screen, the display apparatus is caused to display the monitoring screen further including a region where the situation is displayed.

### [Supplementary Note 19]

The remote monitoring method according to any one of Supplementary notes 15 to 18,
wherein in the reception of the image data, image data is received from a plurality of moving objects, and
in the display of the monitoring screen, the display apparatus is caused to display the monitoring screens of the plurality of moving objects.

### [Supplementary Note 20]

The remote monitoring method according to any one of Supplementary notes 15 to 19, further comprising transmitting, when the control content is not selected within a time limit, a control signal for stopping the moving object to the moving object.

### [Supplementary Note 21]

The remote monitoring method according to Supplementary note 20,
wherein in the display of the monitoring screen, the display apparatus is caused to display a remaining time of the time limit.

### REFERENCE SIGNS LIST

10 REMOTE MONITORING SYSTEM
20 MOVING OBJECT
30 REMOTE MONITORING APPARATUS
31 IMAGE RECEPTION MEANS
32 CANDIDATE ACQUISITION MEANS
33 MONITORING SCREEN DISPLAY MEANS
34 CONTROL CONTENT TRANSMISSION MEANS
100 REMOTE MONITORING SYSTEM
110 REMOTE MONITORING APPARATUS
111 IMAGE RECEPTION UNIT
112 SITUATION RECOGNITION UNIT
113 DEFINITION INFORMATION STORAGE UNIT
114 CONTROL CONTENT SEARCH UNIT
115 MONITORING SCREEN DISPLAY UNIT
116 CONTROL CONTENT INPUT UNIT
117 CONTROL CONTENT TRANSMISSION UNIT
121 OBJECT DETECTION UNIT
122 OBJECT TRACING UNIT
123 DISTANCE ESTIMATION UNIT
124 LANE DETECTION UNIT
125 IMAGE DELAY MEASUREMENT UNIT
130 MONITORING SCREEN DISPLAY APPARATUS
150 NETWORK
200 MOVING OBJECT
201 PERIPHERY MONITORING SENSOR
202 VEHICLE SENSOR
203 VEHICLE CONTROL ECU
204 SELF-DRIVING ECU
205 COMMUNICATION APPARATUS
206 IMAGE TRANSMISSION UNIT
207 CONTROL CONTENT RECEPTION UNIT
300 MONITORING SCREEN
301 IMAGE DISPLAY REGION
302 SITUATION DISPLAY REGION
303 CONTROL CONTENT DISPLAY REGION
310 FRAME
320 POSITION DISPLAY REGION
330 PROGRESS BAR
350 DISPLAY SCREEN
500 COMPUTER APPARATUS
510 CPU
520 STORAGE UNIT
530 ROM
540 RAM
550 COMMUNICATION IF
560 USER IF

What is claimed is:

1. A remote monitoring system comprising:
one or more moving objects configured to be capable of autonomous driving; and
a remote monitoring apparatus that is used for monitoring the moving objects,
wherein the remote monitoring apparatus comprises
a memory storing instructions; and
a processor configured to execute the instructions to:
receive image data obtained by imaging an outside of the moving object from the moving object,
acquire control content candidates including one or more control contents of autonomous driving based on information regarding autonomous driving in the moving object,
cause a display apparatus to display a monitoring screen including a region where the image data is displayed and a region where the control content candidates are displayed, and
transmit, when one control content is selected from the control content candidates, a control signal representing the selected control content to the moving object, and
the moving object receives the transmitted control signal, and executes autonomous driving according to the control content represented by the received control signal.

2. The remote monitoring system according to claim 1, the processor is further configured to execute the instructions to recognize a situation of the moving object based on the image data,
wherein the processor is configured to execute the instructions to acquire the control content candidates based on the recognized situation.

3. The remote monitoring system according to claim 2,
wherein processor is configured to execute the instructions to acquire, using definition information that defines a correspondence between the situation and one or more control contents of autonomous driving that are selectable in the situation, one or more control contents of autonomous driving corresponding to the recognized situation as the control content candidates.

4. The remote monitoring system according to claim 2,
wherein the monitoring screen further includes a region where the situation is displayed.

5. The remote monitoring system according to claim 1,
wherein the remote monitoring system includes a plurality of moving objects, and
the processor is configured to cause the display apparatus to display the monitoring screens of the plurality of moving objects.

6. The remote monitoring system according to claim 1,
wherein when the control content is not selected within a time limit, the processor is configured to execute the instructions to transmit a control signal for stopping the moving object to the moving object.

7. The remote monitoring system according to claim 6,
wherein the processor is configured to execute the instructions to cause the display apparatus to display a remaining time of the time limit.

8. A remote monitoring apparatus comprising:
a memory storing instructions; and
a processor configured to execute the instructions to:
receive, from a moving object configured to be capable of autonomous driving, image data obtained by imaging an outside of the moving object;
acquire control content candidates including one or more control contents of autonomous driving based on information regarding autonomous driving in the moving object;
cause a display apparatus to display a monitoring screen including a region where the image data is displayed and a region where the control content candidates are displayed; and
transmit, when one control content is selected from the control content candidates, a control signal representing the selected control content to the moving object.

9. The remote monitoring apparatus according to claim 8, the processor is further configured to recognize a situation of the moving object based on the image data,
wherein the processor is configured to execute the instructions to acquire the control content candidates based on the recognized situation.

10. The remote monitoring apparatus according to claim 9,
wherein the processor is configured to execute the instructions to acquire, using definition information that defines a correspondence between the situation and one or more control contents of autonomous driving that are selectable in the situation, one or more control contents of autonomous driving corresponding to the recognized situation as the control content candidates.

11. The remote monitoring apparatus according to claim 9,
wherein the monitoring screen further includes a region where the situation is displayed.

12. The remote monitoring apparatus according to claim 8,
wherein the processor is configured to execute the instructions to receive image data from a plurality of moving objects, and
the processor is configured to execute the instructions to cause the display apparatus to display the monitoring screens of the plurality of moving objects.

13. The remote monitoring apparatus according to claim 8,
wherein when the control content is not selected within a time limit, the processor is configured to execute the instructions to transmit a control signal for stopping the moving object to the moving object.

14. The remote monitoring apparatus according to claim 13,
wherein the processor is configured to execute the instructions to cause the display apparatus to display a remaining time of the time limit.

15. A remote monitoring method comprising:
receiving, from a moving object configured to be capable of self-driving, image data obtained by imaging an outside of the moving object;
acquiring control content candidates including one or more control contents of autonomous driving based on information regarding autonomous driving in the moving object;
causing a display apparatus to display a monitoring screen including a region where the image data is displayed and a region where the control content candidates are displayed; and
transmitting, when one control content is selected from the control content candidates, a control signal representing the selected control content to the moving object.

16. The remote monitoring method according to claim 15, further comprising recognizing a situation of the moving object based on the image data,
wherein the recognized situation is used as the information regarding autonomous driving in the moving object, and the control content candidates are acquired based on the recognized situation.

17. The remote monitoring method according to claim 16,
wherein one or more control contents of autonomous driving corresponding to the recognized situation are acquired as the control content candidates by referring to definition information that defines a correspondence between the situation of the moving object and one or more control contents of autonomous driving that are selectable in the situation.

18. The remote monitoring method according to claim 16,
wherein the display apparatus is caused to display the monitoring screen further including a region where the situation is displayed.

19. The remote monitoring method according to claim 15,
wherein image data is received from a plurality of moving objects, and
the display apparatus is caused to display the monitoring screens of the plurality of moving objects.

20. The remote monitoring method according to claim 15, further comprising transmitting, when the control content is not selected within a time limit, a control signal for stopping the moving object to the moving object.

21. (canceled)
